(19) United States
(12) Patent Application Publication
(10) Pub. No.: US 2012/0040051 A1
(43) Pub. Date: Feb. 16, 2012

(54) PROCESS FOR PREPARING MILK PRODUCT ENHANCED WITH GALACTOOLIGOSACCHARIDE AND EASILY ABSORBABLE, AND FUNCTIONAL MILK PRODUCT PREPARED THEREWITH

(76) Inventors: KWAN-HAN CHEN, Chiayi (TW); Chien-Teng Fan, Chiayi (TW); Chun-Liang Chou, Chiayi (TW); Tzu-Hsin Liu, Chiayi (TW); Chien-Yu Chen, Chiayi (TW); Hui-Min Lai, Chiayi (TW)

(21) Appl. No.: 13/110,677

(22) Filed: May 18, 2011

(30) Foreign Application Priority Data
Aug. 13, 2010 (TW) 099127161

(51) Int. Cl. A23C 9/12

(52) U.S. Cl. 426/41; 426/42; 426/580

(57) ABSTRACT

Most milk products in the market are promoted in terms of their nutritional value, rather than the function thereof. For the few products claiming to have a special function, the function comes from substances added to the products rather than from the milk material per se. Some products are claimed to have low lactose content, but there are no milk products in the market that have both low lactose content and high galactooligosaccharide content. The invention is cost effective as compared with milk products with added functional substances. The subject invention relates to a process for production of a milk product enhanced with galactooligosaccharide, characterized in that lactase is used to treat milk raw materials. The subject invention further relates to the milk product of the process of the invention, whose galactooligosaccharide content is at function level.

### FIELD OF THE INVENTION

The present invention relates to a process for preparing easily absorbable milk products with high galactooligosaccharide (GOS) content and low lactose content, and to a galactooligosaccharide-enhanced milk product prepared with the process.

### BACKGROUND OF THE INVENTION

Milk is a highly nutritious food containing many important nutrients, including proteins, fats, amino acids, minerals and vitamins. Medical and nutritional research papers have shown that consuming milk has the effect of preventing bone mass loss.

Milk proteins are not easily digested and absorbed, however, by humans. Casein, one of the proteins found in milk, is a large protein molecule that needs to be digested and decomposed into small molecules by human enzymes before being absorbed. The sugar component in milk is lactose. In humans with insufficient lactase secretion, lactose is fermented by enteric bacteria to form lactic acids, carbon dioxide and other organic acids, which in turn cause osmotic pressure imbalance and give rise to symptoms of lactose intolerance such as diarrhea, abdominal pain and abdominal bloating.

It is known that the benefits of galactooligosaccharide include lowering of enteric pH value, promotion of intestinal motility, inhibition of the growth of harmful bacteria and reduction of toxins produced by harmful bacteria. Galactooligosaccharide is thus useful in maintaining in vivo body hygiene and enhancing body functions. It is an important functional component in breast milk and cow's milk.

U.S. Pat. No. 5,032,509 discloses a method of preparing galacatooligosaccharide comprising treating lactose with β-galactosidase and glucose isomerase. In one embodiment, the method comprises treating a lactose solution containing 60% (w/w) of solid content lactose with β-galactosidase in a buffer solution of pH 4.5 at 70° C. for 2 hours so as to obtain galactooligosaccharide. Then glucose isomerase was added and reacted at pH 7.5 and 60% for 16 hours so as to convert glucose (a hydrolysis product of lactose) to fructose. The resultant sugar liquid comprised solid content having a concentration of 60% (w/w), the sugar in the solid content being composed of 28.4% galactooligosaccharides, 52.4% disaccharides, 8.0% glucose. 8.1% fructose and 3.1% galactose. Such sugar liquid can be used as a substitute for sugar or as a food additive.

U.S. Pat. No. 5,378,833 discloses a method of preparing galacatooligosaccharides. In one embodiment. the method comprises treating the mixture of lactose and galactose, wherein the ratio is 9:1 to 5:5 and is preferably 8:2 to 7:3, with inorganic acids such as hydrochloric acid, nitric acid, phosphoric acid and sulfuric acid at temperature of 100 to 200t for 0.5 to 3 hours, preferably for 1 to 2 hours. The conversion rate of the method to obtain galactooligosaccharide is more than 80%. The powder obtained from the above method was neutralized. decolorized, desalted, concentrated and spray dried to produce the final powder products.

ROC Patent Application No. 095130588 discloses a method for preparing a milk product containing low lactose and low glucose. In one embodiment, the method comprises using a yeast. or a lactase to treat a milk starting material and fermenting the milk material at a temperature of 15 to 35° C. for 10 to 48 hours. The lactose content of the resultant milk product is reduced to less than 50% of that of the starting material, and the glucose content of the resultant milk product is reduced to less than 50% of that of the starting material. The yeast fermented milk products may have a yeasty flavor. If necessary, flavorings may be added to mask the yeasty flavor.

CN Patent Publication No. 1903052 discloses a method for preparing whey powder containing casein phosphopeptide, anti-angiotonin converzyme peptide and oligo-galactose. The method comprises the steps of (1) fermenting mammalian milk with lactic acid bacteria and adding chymosin during fermentation to obtain milk curd, (2) heating, breaking and filtrating the curd to obtain a whey solution, (3) concentrating the whey solution to obtain concentrated whey solution containing 75 to 90% protein, (4) treating the concentrated whey solution with trypsin, pepsin and galactosidase at a temperature of 35 to 60° C. for 1 to 4 hours, (5) inactivating the enzymes, (6) conducting vaccum-drying at a temperature of 40 to 50° C. to obtain concentrated hydrolyzed whey. (7) conducting spray-drying to obtain whey powder containing casein phosphopeptide, anti-angiotonin converzyme peptide and oligo-galactose.

Furthermore, CN Patent Publication No. 1349998 discloses the synthesis of galactose 3,6 places branching oligose with important biological function by using 1,2,5,6-di-O-isopropylidene-alpha-D-galatofuranose as initiation raw material.

The methods of preparing galactooligosaccharide disclosed by the above-mentioned prior art are chemical synthesis methods, some of which involve complicated steps and require extensive time for yeast fermentation and enzyme reaction, resulting in high production costs. There exists a need of a non-chemical synthesis method which can efficiently produce galactooligosaccharide.

In addition, none of the prior art provides a method which enhances other functions in a milk product while increasing the galactooligosaccharide thereof, for example, lowering lactose content in a milk product to prevent symptoms of lactose intolerance while increasing galactooligosaccharide content thereof.

### SUMMARY OF THE INVENTION

The present invention provides an enzymatic hydrolysis method for producing a milk product enhanced with galactooligosaccharide. The enzymatic hydrolysis method of the invention reduces the lactose content of a milk product.

One object of the invention is to provide an enzymatic hydrolysis method comprising converting lactose in milk materials to galactooligosaccharide by using a lactase to obtain a milk product with high galactooligosaccharide content.

The “milk materials” used in the invention may be from any mammals and include. but are not limited to, milk materials from cows. goats or sheep. Preferably, the milk materials are cow's milk, goat's milk or sheep's milk. More preferably, the milk materials are cow's milk. The milk used in the invention can be modified before being treated by the method of the invention. For example, the milk materials can be converted to skim milk, low-fat milk, whey proteins, whey, lactoferrin, or lactose. Therefore, the term “milk materials” can include skim milk, low-fat milk, whey proteins, whey, lactoferrin, and lactose.

The milk materials used in the method of the invention can be highly concentrated. In one embodiment of the invention, the milk materials used in the method contain 14% (w/w) of solid content. In another embodiment of the invention, the milk materials used in the method contain 40% (w/w) of solid content. The milk materials used in the method of the invention contain about 13 to 60% (w/w), preferably 14 to 40% (w/w), of solid content.

Milk materials can be processed to milk proteins, or milk powder by drying processes and dissolved in water before being used as milk materials in the method of the invention. For example, proteins, cow's milk or milk powder can be dissolved in water.

The method of the invention makes use of lactases from any origin, including, but not limited to, lactases from Aspergillus, Saccharontyces and Kluyveromyces. Preferably. the lactase is β-galactosidase.

Optionally, additional enzymes can be used in the method of the invention to hydrolyze the milk materials which have been treated with the lactase so that the milk products can have additional functions. For example. proteases can be used to convert proteins in the milk materials to amino acids to promote absorption of milk proteins and limit allergic reactions.

Another object of the present invention is to provide a bi-enzymatic hydrolysis method comprising converting lactose in milk materials to galactooligosaccharide with lactases and proteins to amino acids with proteases to obtain milk products with high galactooligosaccharide content and reduced allergenic casein.

The method of the invention makes use of proteases from any origin. including, but not limited to, flavorurzyrne and proteases from fungi such as Aspergillus oryze.

The enzymatic hydrolysis reaction can he practiced on the basis of reaction conditions of enzymatic reactions known by persons having ordinary skill in the art. As can be appreciated by persons having ordinary skill in the art, the amount of enzymes and the reaction temperature and reaction time for the method of the invention can be determined on the basis of the milk materials employed, the enzyme added, and the end product.

In accordance with the method of the invention, about 0.1 to 0.5% (w/w) of lactase is used. Preferably, about 0.2 to 0.3% (w/w) lactase is used. In accordance with the method of the invention, about 0.1 to 0.5% (w/w) protease is used. Preferably, about 0.2 to 0.3% (w/w) protease is used.

According to the invention, the enzymatic reaction is carried out at a temperature between 30 to 60° C. Preferably, the enzymatic hydrolysis reaction is carried out between 40 to 50° C.

According to the invention, the enzymatic hydrolysis reaction is carried out for 30 to 120 minutes. Preferably, the enzymatic reaction is carried out for 60 to 90 minutes.

Any known process can be adapted to terminate enzymatic reactions after enzymatic treatment, for example. heating the milk to inactivate the enzymes and then cooling it. The temperature for heating and inactivating the enzymes is about 60 to 90° C., preferably 70 to 80° C. After enzyme inactivation, the temperature is cooled to about 20° C., preferably 10° C.

Finally, the products obtained after enzyme inactivation can be sterilized by the processes known for treating milk products. For example, the products can be sterilized by pasteurization or Ultra High Temperature (UHT).

Optionally, the end products can be packed in an aseptic cool filling system.

The milk products obtained after enzyme treatment in accordance with the method of the invention (with 8 to 60% (w/w) solid content) contain about 0.3 to 8% (w/w) galactooligosaccharide. The final liquid milk products (with 7 to 28% (w/w) solid content) contain about 0.2 to 5% (w/w) galactooligosaccharide. Preferably, the enzyme-treated milk products obtained in accordance with the method of the invention (with 8 to 60% (w/w) solid content) contain about 2 to 6% (w/w) galactooligosaccharide. The final liquid milk products (with 7 to 28% (w/w) solid content) contain about 0.5 to 3% (w/w) galactooligosaccharide.

The milk products obtained after enzyme treatment in accordance with the method of the invention (with 40% (w/w) solid content) contain less than about 4% (w/w) lactose. The final liquid milk products (with 12% (w/w) solid content) contain less than about 1.5% (w/w) lactose. Preferably, the enzyme-treated milk products obtained in accordance with the method of the invention (with 40% (w/w) solid content) contain less than about 3% (w/w) lactose. The final liquid milk products (with 12% (w/w) solid content) contain less than about 1% (w/w) lactose.

Therefore, the further object of the invention is to provide a milk product with high galactooligosaccharide content and low lactose content and which is easily absorbed.

The milk products of the invention can be prepared as milk drinks which can be preserved under normal temperature or refrigerated. The milk products of the invention can also be used to make ice cream, milk shakes, flavored milk, yogurt drinks, functional drinks or snacks.

### DETAILED DESCRIPTION OF THE INVENTION

The following examples are provided to further describe the present invention and by no means limit the invention.

The reaction conditions and the amounts of galactooligosaccharide for Examples 1 to 8 are disclosed in Table 1 below.

### Example 1

Adding a lactase obtained from Aspergillus to CNS3056 whole milk (containing 12% solid content) in an amount of 0.1 g lactase per 100 g lactose. Reacting the mixture at 4° C. for 0 to 24 hours. The milk products obtained at 0 and 24 hours have 0 g and 0.13 g galactooligosaccharide, respectively, per 100 g of the milk products.

### Example 2

Adding a lactase obtained from Aspergillus to CNS3056 whole milk (containing 12% solid content) in an amount of 0.1 g lactase per 100 g lactose. Reacting the mixture at 50° C. for 0 to 2 hours. The milk products obtained at 0 and 2 hours have 0 g and 0.285 g galactooligosaccharide, respectively, per 100 g of the milk products.

### Example 3

Dissolving milk powder in water at 55° C. to form a high concentration milk liquid (containing 14% (w/w) solid content). Adding a lactase obtained from Aspergillus to the milk liquid in an amount of 0.1 g lactase per 100 g lactose. Reacting the mixture at 50° C. for 0 to 120 minutes. The milk products obtained at 0, 30. 60 and 120 minutes have 0 g, 2.2 g, 4.86 g and 4.65 g galactooligosaccharide. respectively, per 100 g of the milk products.

### Example 4

Dissolving milk powder in water at 55° C. to form a high concentration milk liquid (containing 40% (w/w) solid content). Adding a lactase obtained from Aspergillus to the milk liquid in an amount of 0.1 g lactase per 100 g lactose. Reacting the mixture at 50° C. for 0 to 120 minutes. The milk products obtained at 0, 30, 60 and 120 minutes have 0 g, 1.08 g, 1.16 g and 0.85 g galactooligosaccharide, respectively, per 100 g of the milk products.

### Example 5

Dissolving milk powder in water at 55° C. to form a high concentration milk liquid (containing 14% (w/w) solid content). Adding a lactase obtained from Saccharomyces to the milk liquid in an amount of 0.1 g lactase per 100 g lactose. Reacting the mixture at 50° C. for 0 to 120 minutes. The milk products obtained at 0, 30, 60 and 120 minutes have 0 g, 3.17 g, 4.3 g and 4.9 g galactooligosaccharide, respectively, per 100 g of the milk products.

### Example 6

Dissolving milk powder in water at 55° C. to form a high concentration milk liquid (containing 40% (w/w) solid content). Adding a lactase obtained from Saccharomyces to the milk liquid in an amount of 0.1 g lactase per 100 g lactose. Reacting the mixture at 50° C. for 0 to 120 minutes. The milk products obtained at 0. 30, 60 and 120 minutes have 0 g, 1.01 g, 0.80 g and 0.84 g galactooligosaccharide, respectively, per 100 g of the milk products.

### Example 7

Dissolving milk powder in water at 55° C. to form a high concentration milk liquid (containing 14% (w/w) solid content). Adding a lactase obtained from Kluyveromyces to the milk liquid in an amount of 0.1 g lactase per 100 g lactose. Reacting the mixture at 50° C. for 0 to 120 minutes. The milk products obtained at 0, 30, 60 and 120 minutes have 0 g, 4.3 g, 5.19 g and 5.07 g galactooligosaccharide, respectively, per 100 g of the milk products.

### Example 8

Dissolving milk powder in water at 55° C. to form a high concentration milk liquid (containing 40% (w/w) solid content). Adding a lactase obtained from Kluyveromyces to the milk liquid in an amount of 0.1 g lactase per 100 g lactose. Reacting the mixture at 50° C. for 0 to 120 minutes. The milk products obtained at 0, 30, 60 and 120 minutes have 0 g, 1.12 g, 1.53 g and 0.96 g galactooligosaccharide, respectively, per 100 g of the milk products.

The reaction conditions and the amounts of galactooligosaccharide for Examples 1 to 8 are disclosed in Table 1 below.

| | | | | | GOS |
|---|---|---|---|---|---|
| | | | | GOS | Content |
| | | | | Content | of the Final |
| | | | | of | Liquid Milk |
| | Solid | Origins of | | Enzyme- | Products |
| | Content | Enzymes | Reaction | Treated | (12% solid |
| Ex- | (% | (reaction | Time | Products | content) |
| ample | w/w) | temperature) | (minutes) | (g/100 g) | (g/100 g) |
| 1 | 12 | Aspergillus | 0 | 0 | 0 |
| | | (4□) | 1440 | 0.13 | 0.13 |
| 2 | 12 | Aspergillus | 0 | 0 | 0 |
| | | (50□) | 120 | 0.285 | 0.285 |
| 3 | 14 | Aspergillus | 0 | 0 | 0 |
| | | (50□) | 30 | 1.08 | 0.93 |
| | | | 60 | 1.16 | 0.99 |
| | | | 120 | 0.85 | 0.72 |
| 4 | 40 | Aspergillus | 0 | 0 | 0 |
| | | (50□) | 30 | 2.2 | 0.66 |
| | | | 60 | 4.86 | 1.45 |
| | | | 120 | 4.65 | 1.39 |
| 5 | 14 | Saccharomyces | 0 | 0 | 0 |
| | | (50□) | 30 | 1.01 | 0.86 |
| | | | 60 | 0.89 | 0.76 |
| | | | 120 | 0.84 | 0.72 |
| 6 | 40 | Saccharomyces | 0 | 0 | 0 |
| | | (50□) | 30 | 3.17 | 0.95 |
| | | | 60 | 4.3 | 1.29 |
| | | | 120 | 4.9 | 1.47 |
| 7 | 14 | Kluyveromyces | 0 | 0 | 0 |
| | | (50□) | 30 | 1.12 | 0.96 |
| | | | 60 | 1.53 | 1.31 |
| | | | 120 | 0.96 | 0.82 |
| 8 | 40 | Kluyveromyces | 0 | 0 | 0 |
| | | (50□) | 30 | 4.3 | 1.29 |
| | | | 60 | 5.19 | 1.55 |
| | | | 120 | 5.07 | 1.52 |

Heating the milk liquid in Examples 1 to 8 to 70 to 80° C. to inactive the enzymes and then cooling to 10 to 20° C. Sterilizing the milk liquid by UHT (at a temperature of 140° C. for 30 seconds) and packing it in an aseptic cool filling system.

The above is merely an exemplary embodiment of the subject invention and should not be construed as limitation of the present invention. Moreover, it will be understood that modifications and variations can be made by those of ordinary skill in the art without departing from the spirit and scope of the invention.

1. A method for producing a milk product with high galactooligosaccharide content and low lactose content characterized by directly treating milk materials with a lactase.

2. The method of claim 1, wherein the milk materials are from mammals.

3. The method of claim 2, wherein the milk materials are cow's milk, goat's milk or sheep's milk.

4. The method of claim 1, wherein the milk materials are obtained by dissolving raw milk, milk powder or whey proteins in water.

5. The method of claim 1, wherein the milk materials are highly concentrated.

6. The method of claim 1, wherein the lactase is β-galactosidase or a lactase from Aspergillus, Saccharomyces or Kluyveromyces.

7. The method of claim 1, wherein about 0.1 to 0.5% (w/w) lactase is used.

8. The method of claim 1, further comprises treating the lactase-treated milk materials with proteases.

9. The method of claim 8, wherein the protease is flavorurzyme or a fungus protease from Aspergillus oryze.

10. The method of claim 8, wherein about 0.1 to 0.5% (w/w) protease is used.

11. The method of claim 1, wherein the enzymatic reaction is carried out at a temperature of about 30 to 60° C.

12. The method of claim 8, wherein the enzymatic reaction is carried out at a temperature of about 30 to 60° C.

13. The method of claim 1, wherein the milk materials are heated to inactivate the enzyme after the enzyme treatment.

14. The method of claim 8, wherein, wherein the milk materials are heated to inactivate the enzyme after the enzyme treatment.

15. The method of claim 13, further comprising sterilization by Ultra High Temperature (UHT).

16. The method of claim 14, further comprising sterilization by Ultra High Temperature (UHT).

17. The method of claim 15, further comprising packing the resultant milk products in an aseptic cool filling system.

18. The method of claim 16, further comprising packing the resultant milk products in an aseptic cool filling system.

19. A milk product enhanced with galactooligosaccharide produced from the method of claim 1.

20. The milk product of claim 19. wherein the resultant milk products obtained after enzymatic treatment have 8 to 60% (w/w) solid content and about 0.3 to 8% (w/w) galactooligosaccharide.

21. The milk product of claim 19. wherein the final liquid milk products have 7 to 28% (w/w) solid content and about 0.2 to 5% (w/w) galactooligosaccharide.

22. The milk product of claim 19, wherein the resultant milk products obtained after enzymatic treatment contain 40% (w/w) solid content and less than about 4% (w/w) lactose, and the final liquid milk products contain 12% (w/w) solid content and contain less than about 1.5% (w/w) lactose.
